(19) United States
(12) Patent Application Publication
(10) Pub. No.: US 2026/0051558 A1
(43) Pub. Date: Feb. 19, 2026

(54) Cooling Control Device and Method for Delaying Thermal Runaway of Battery

(71) Applicants: Hyundai Motor Company, Seoul (KR); Kia Corporation, Seoul (KR)

(72) Inventor: Junghyun Lee, Hwaseong-Si (KR)

(21) Appl. No.: 19/052,500

(22) Filed: Feb. 13, 2025

(30) Foreign Application Priority Data
Aug. 19, 2024 (KR) 10-2024-0110547

(51) Int. Cl. H01M 10/633; H01M 10/42; H01M 10/613; H01M 10/625; H01M 10/6568

(52) U.S. Cl. CPC H01M 10/633; H01M 10/425; H01M 10/613; H01M 10/625; H01M 10/6568; H01M 2010/4271; H01M 2220/20

(57) ABSTRACT

A cooling control device for delaying thermal runaway of a battery includes a thermal runaway diagnosis unit configured to diagnose a thermal runaway state of the battery, and a controller configured to drive the chiller in response to diagnosis of the thermal runaway state of the battery when a chiller for cooling the battery is allowed to be dri

### CROSS-REFERENCE TO RELATED PATENT APPLICATION

This application claims priority to Korean Patent Application No. 10-2024-0110547, filed Aug. 19, 2024, whose entire disclosures are hereby incorporated by reference.

### TECHNICAL FIELD

The present disclosure relates to a cooling control device and method for delaying thermal runaway of a battery.

### BACKGROUND

Thermal runaway of a battery refers to a phenomenon in which loss of power and conversion into thermal energy in an element increases a temperature to increase current, so that the temperature further increases to cause thermal instability, eventually damaging the element.

When thermal runaway occurs in a high-voltage battery used in a vehicle (e.g., an eco-friendly vehicle, such as an electronic vehicle (EV), a hybrid EV (HEV), a plug-in HEV (PHEV)), thermal runaway of the battery has been addressed by suppressing additional short-circuiting through circuit blocking (main relay open) of the high-voltage battery. Also, or alternatively, to delay thermal runaway of the battery, thermal runaway has been addressed by hardware improvements/modification, such as reinforcing a bus bar, adding a heat-resistant pad, and/or applying a venting valve to release high-temperature gas.

However, in the case of the conventional technology, when thermal runaway of the battery occurs, power to the battery is cut off (main relay open), so that a chiller that may most effectively delay thermal transfer cannot be operated, and thus there has been a problem in that delay of thermal runaway of the battery is insufficient.

The matters described in this Background section are only for enhancement of understanding of the background of the disclosure, and should not be taken as acknowledgement that they correspond to prior art already known to those skilled in the art.

### SUMMARY

The following summary presents a simplified summary of certain features. The summary is not an extensive overview and is not intended to identify key or critical elements.

Systems, apparatuses, and methods are described for a cooling control device and method for delaying thermal runaway of battery. A cooling control device for delaying thermal runaway of a battery may comprise: a thermal runaway diagnosis computing device configured to diagnose a thermal runaway state of the battery; and a controller configured to, in response to the diagnosed thermal runaway state of the battery: drive, based on a determination that a chiller powered by the battery is able to be driven, the chiller to cool the battery.

Also, or alternatively, a cooling control device for delaying thermal runaway of a battery may comprise: a thermal runaway diagnosis unit configured to diagnose a thermal runaway state of the battery; and a controller configured to, based on the diagnosed thermal runaway state of the battery, control cooling of the battery, wherein the cooling of the battery is controlled either in a first cooling mode based on a determination that a chiller for cooling the battery is able to be driven or in a second cooling mode based on a determination that the chiller is not able to be driven.

Also, or alternatively, a cooling control method for delaying thermal runaway of a battery may comprise: diagnosing a thermal runaway state of the battery; and driving, based on a determination that a chiller powered by the battery is able to be driven, the chiller to cool the battery.

Also, or alternatively, a cooling control method for delaying thermal runaway of a battery may comprise: diagnosing a thermal runaway state of the battery; and based on the diagnosed thermal runaway state of the battery, controlling cooling of the battery, wherein the cooling of the battery is controlled either in a first cooling mode based on a determination that a chiller for cooling the battery is able to be driven or in a second cooling mode based on a determination that the chiller is not able to be driven.

A vehicle may comprise a cooling control device for delaying thermal runaway of a battery of the vehicle. The cooling control device may be as disclosed herein and/or may be configured to perform one or more functions of the methods disclosed herein.

These and other features and advantages are described in greater detail below.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a configuration diagram of a cooling control device for delaying battery thermal runaway according to an example of the present disclosure;

FIG. 2 is a flowchart of a cooling control method for delaying battery thermal runaway according to an example of the present disclosure; and

FIG. 3 is a diagram for describing a flow path of a first cooling mode (battery-only cooling mode) and a second cooling mode (battery/power electric (PE)-integrated cooling mode) according to an example of the present disclosure.

### DETAILED DESCRIPTION

Hereinafter, reference will be made in detail to examples of the present disclosure, in view of the accompanying drawings. Wherever possible, the same or similar elements will be denoted by the same reference numerals even though they are depicted in different drawings and a redundant description thereof will thus be omitted. In the following description of the examples, suffixes, such as “module” and “part”, are provided or used interchangeably merely in consideration of ease in statement of the specification, and do not have meanings or functions distinguished from one another. In the following description of the examples of the present disclosure, a detailed description of known functions and configurations incorporated herein will be omitted when it may make the subject matter of the present disclosure rather unclear. Further, the accompanying drawings will be exemplarily given to describe the examples of the present disclosure, and should not be construed as being limited to the examples set forth herein, and it will be understood that the examples of the present disclosure are provided only to completely disclose the disclosure and cover modifications, equivalents or alternatives which come within the scope and technical range of the disclosure.

In the following description of the examples, terms, such as “first” and “second”, are used only to describe various elements, and these elements should not be construed as being limited by these terms. These terms are used only to distinguish one element from other elements.

When an element or layer is referred to as being “connected to” or “coupled to” another element or layer, it may be directly connected or coupled to the other element or layer, or intervening elements or layers may be present. In contrast, when an element or layer is referred to as being “directly connected to” or “directly coupled to” another element or layer, there may be no intervening elements or layers present.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, and C”, “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

Throughout the present disclosure, references to components, units, or modules generally refer to items that logically can be grouped together to perform a function or group of related functions. Like reference numerals are generally intended to refer to the same or similar components. Components, units, and modules may be implemented in software, hardware or a combination of software and hardware. The components, units, modules, and/or functions described above may be implemented and/or performed by one or more processors. For examples, the components, units, and/or modules may include processor(s), microprocessor(s), graphics processing unit(s), logic circuit(s), dedicated circuit(s), application-specific integrated circuit(s), programmable array logic, field-programmable gate array(s), controller(s), microcontroller(s), and/or other suitable hardware. The components, units, and/or modules may also include software control module(s) implemented with a processor or logic circuitry for example. The components, units, and/or modules may include or otherwise be able to access memory such as, for example, one or more non-transitory computer-readable storage media, such as random-access memory, read-only memory, electrically erasable programmable read-only memory, erasable programmable read-only memory, flash/other memory device(s), data registrar(s), database(s), and/or other suitable hardware. One or more storage type media may include any or all of the tangible memory of computers, processors, or the like, or associated modules thereof, such as various semiconductor memories, tape drives, disk drives and the like, which may provide non-transitory storage at any time for software programming.

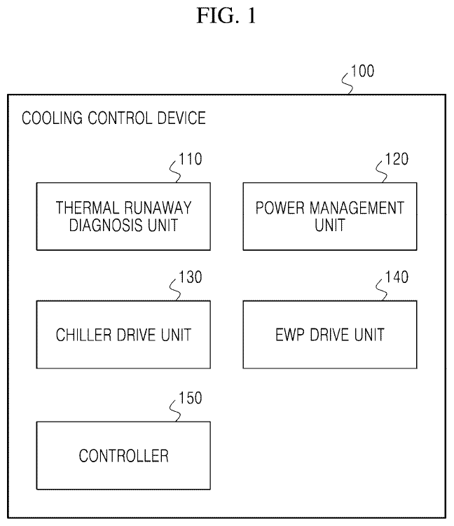

Hereinafter, a cooling control device and method for delaying battery thermal runaway according to the present disclosure will be described in detail with reference to FIGS. 1 to 3.

FIG. 1 is a configuration diagram of the cooling control device for delaying battery thermal runaway according to an example of the present disclosure.

Referring to FIG. 1, a cooling control device 100 for delaying battery thermal runaway according to an example of the present disclosure may include a thermal runaway diagnosis unit 110, a power management unit 120, a chiller drive unit 130, an electric water pump (EWP) drive unit 140, a controller 150, etc.

The thermal runaway diagnosis unit 110 may be configured to diagnose a thermal runaway state of a battery. For example, the thermal runaway diagnosis unit 110 may diagnose a thermal runaway state of the battery (e.g., in real time) based on changes in a state of charge (SoC) of the battery, a change in a state of safety (SoS) of the battery, a change in temperature of the battery, a change in internal resistance of the battery, high-temperature gas detection, and/or other thermal runaway diagnosis indicators. The thermal runaway diagnosis unit 110 may be linked to a battery management system (BMS) and/or directly implemented as a BMS.

The power management unit 120 may manage power for one or more components of the vehicle, such as an ignition device, a vehicle control unit (VCU), a vehicle platform controller (VPC), full automatic temperature control (FATC), and/or a battery, etc.

For example, the power management unit 120 may determine a power state (e.g., on/off state) of the ignition device (e.g., based on information from with the ignition device). The power management unit 120 may control power (on/off) of the VCU, the VPC, the FATC, the battery, etc. (e.g., by transmitting control information to the VCU, the VPC, the FATC, the battery, etc.).

The chiller drive unit 130 may drive a chiller (for example, an air conditioner) to cool the battery. The chiller unit 130 may, under the control of the controller 150, drive the chiller. For example, upon (e.g., based on) receiving a control signal for maximum driving of the chiller from the controller 150, the chiller drive unit 130 may drive the chiller to the maximum to maximize battery cooling.

The EWP drive unit 140 may drive the EWP to cool the battery. the EWP drive unit 140 may, under control of the controller 150, drive the EWP. For example, upon (e.g., based on) receiving a control signal for maximum driving of the EWP from the controller 150, the EWP drive unit 140 drive may the EWP to the maximum to maximize battery cooling.

The controller 150 may perform cooling control to delay battery thermal runaway in conjunction with at least one of the thermal runaway diagnosis unit 110, the power management unit 120, the chiller drive unit 130, the EWP drive unit 140, etc. The controller 150 may include a communication device communicating with other controllers and/or a sensor to control one or more functions and/or operations in charge, a memory storing an operation system, a logic command, and input/output information, and/or one or more processors performing determination, calculation, and decision necessary for controlling the function in charge. The controller 150 may include, for example, a processor, a central processing unit (CPU), a microchip, a logic, an application-specific integrated circuit (ASIC), memory, etc. The controller 150 may manipulate and/or control other components in the system (e.g., vehicle).

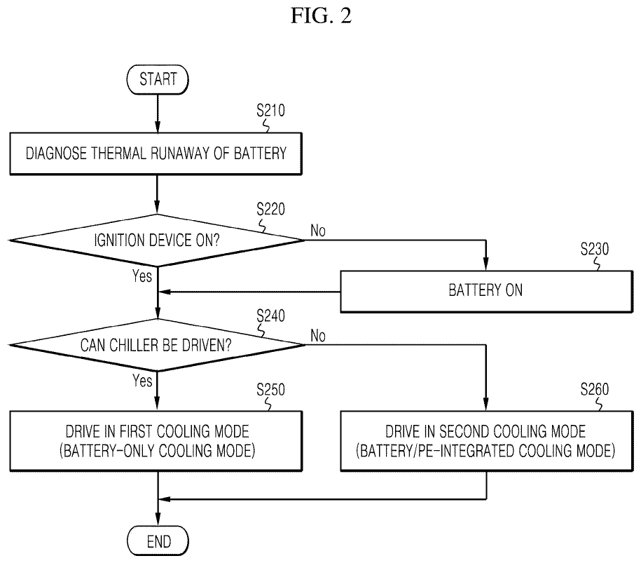

FIG. 2 is a flowchart of a cooling control method for delaying battery thermal runaway according to an example of the present disclosure. For convenience, FIG. 2 is described by way of an example in which the steps are performed by a processor circuit (e.g., of the controller 150). One, some, or all steps of the example method of FIG. 2, or portions thereof, may be performed by one or more other circuits. One or some, steps of the example method of FIG. 2 may be omitted, performed in other orders, and/or otherwise modified, and/or one or more additional steps may be added.

Based on the thermal runaway diagnosis unit 110 diagnosing the thermal runaway state of the battery, the thermal runaway diagnosis unit 110 may notify (e.g., send a message indicating the thermal runaway state) the controller 150 of this state (S210) (e.g., the controller 150 may receive information indicating thermal runaway of the battery). The controller 150 may, based on being notified, check a power state (e.g., an on/off state) of the ignition device in conjunction with the power management unit 120 (refer to step S220).

If the controller 150 determines, based on the check of the power state, the ignition device is in an off state (S220—No; for example, when the vehicle is parked), the controller 150 may turn on power of the VCU and/or the VPC in conjunction with (e.g., via) the power management unit 120, and may turn on power of the FATC and/or the battery (S230).

If the controller 150 determines, based on the check of the power state, the ignition device is turned on (S220—Yes; for example, the vehicle is being driven and/or being charged); or after power (e.g., the battery) is turned on (S230), the controller 150 may verify (e.g., in conjunction with and/or based on information from the chiller drive unit 130) whether normal driving of the chiller is possible (e.g., whether the chiller is able to be driven by the battery as normal, e.g., the battery has sufficient charge) (S240). For example, the controller 150 may verify/determine that normal driving of the chiller (e.g., an air conditioning compressor) is possible based on information indicating a battery (e.g., high voltage battery) associated with the chiller is able to be powered (e.g., has sufficient charge, etc.)

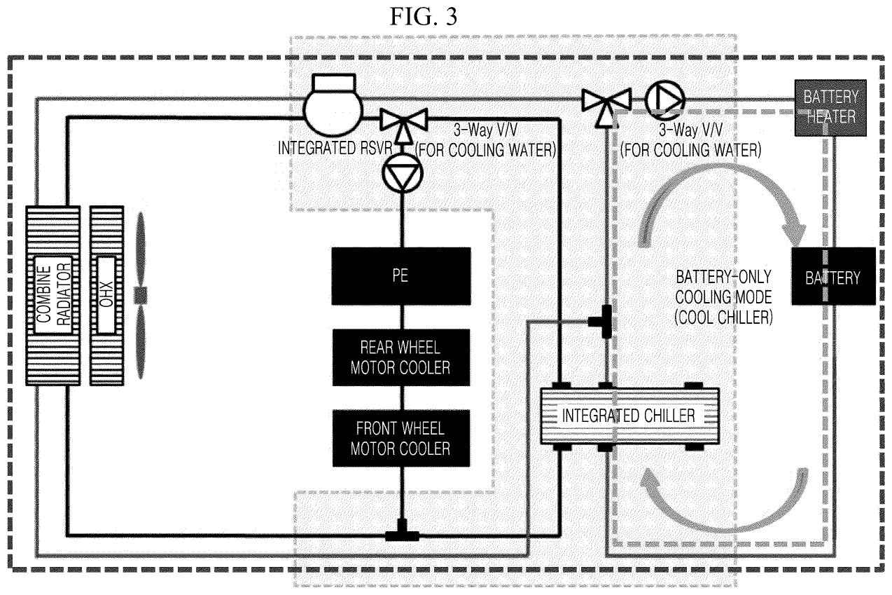

If normal driving of the chiller is possible (S240—Yes), the controller 150 may control cooling of the battery in a first cooling mode (e.g., a battery-only cooling mode) (S250). For example, the controller 150 may form a flow path of a closed loop for battery-only cooling by controlling a 3-way valve, etc. (see an light-gray thick dashed line of FIG. 3), transmit a control signal for maximum driving of the chiller to the chiller drive unit 130 to drive the chiller to the maximum, and transmit a control signal for driving of the EWP to the EWP drive unit 140 to drive the EWP (e.g., send a maximum driving signal to drive the EWP at the maximum, thereby maximizing battery cooling by utilizing both the chiller and the EWP).

The controller 150 may continuously/repeatedly verify whether normal driving of the chiller is possible (e.g., S240) while cooling the battery in the first cooling mode (battery-only cooling mode) (S250). If, at any point, (e.g., while driving cooling in the first cooling mode, or before/without driving cooling in the first cooling mode), the controller 150 determines the chiller cannot be normally driven (S240—No), the controller 150 may switch to driving cooling in the second cooling mode (S260). If normal driving of the chiller is not possible (S240—No), the controller 150 may control cooling of the battery in a second cooling mode (battery/PE-integrated cooling mode) (S260).

For example, the controller 150 may form a flow path for the battery/PE-integrated cooling by controlling a 3-way valve, etc. (see the black thick dashed line of FIG. 3), and transmit a control signal for driving of the EWP to the EWP drive unit 140 to drive the EWP (e.g., a control signal for maximum driving of the EWP to drive the EWP to the maximum, thereby cooling the battery using the EWP).

The present disclosure has been made in view of the above problems, and it is an object of the present disclosure to provide a cooling control device and method for delaying thermal runaway of a battery that delay thermal runaway of the battery by driving a chiller when thermal runaway of the battery occurs.

It is another object of the present disclosure to provide a cooling control device and method for delaying thermal runaway of a battery that delay thermal runaway of the battery by driving a chiller and an electric water pump (EWP) when the chiller may be driven at the time of occurrence of thermal runaway of the battery.

It is a further object of the present disclosure to provide a cooling control device and method for delaying thermal runaway of a battery that delay thermal runaway of the battery by driving an EWP when a chiller cannot be driven at the time of occurrence of thermal runaway of the battery.

Objects of the present disclosure are not limited to the above-mentioned object, and other objects and advantages of the present disclosure, which are not mentioned, will be understood through the following description, and will become apparent from examples of the present disclosure. It is also to be understood that the objects and advantages of the present disclosure may be realized by means and combinations thereof set forth in claims.

In accordance with an aspect of the present disclosure, the above and other objects can be accomplished by the provision of a cooling control device for delaying thermal runaway of a battery comprising a thermal runaway diagnosis unit configured to diagnose a thermal runaway state of the battery, and a controller configured to drive the chiller in response to diagnosis of the thermal runaway state of the battery when a chiller for cooling the battery is allowed to be driven.

The controller may drive the chiller and an electric water pump (EWP) when the chiller is allowed to be driven.

The controller may drive the EWP when the chiller is not allowed to be driven.

The cooling control device may further comprise a power management unit configured to manage the battery, wherein the power management unit turns on power of the battery and supplies power to the chiller when the power of the battery is turned off, under control of the controller.

In accordance with another aspect of the present disclosure, there is provided a cooling control device for delaying thermal runaway of a battery comprising a thermal runaway diagnosis unit configured to diagnose a thermal runaway state of the battery, and a controller configured to control cooling of the battery in a first cooling mode when a chiller for cooling the battery is allowed to be driven and in a second cooling mode when the chiller is not allowed to be driven, in response to diagnosis of the thermal runaway state of the battery.

The first cooling mode may be a mode in which the chiller and the EWP are driven, and the second cooling mode may be a mode in which the EWP is driven.

In accordance with further another aspect of the present disclosure, there is provided a cooling control method for delaying thermal runaway of a battery comprising diagnosing a thermal runaway state of the battery, and driving the chiller in response to diagnosis of the thermal runaway state of the battery when a chiller for cooling the battery is allowed to be driven.

The driving may comprise turning on power of the battery to supply power to the chiller when the power of the battery is turned off.

In accordance with further another aspect of the present disclosure, there is provided a cooling control method for delaying thermal runaway of a battery comprising diagnosing a thermal runaway state of the battery, and controlling cooling of the battery in a first cooling mode when a chiller for cooling the battery is allowed to be driven and in a second cooling mode when the chiller is not allowed to be driven in response to diagnosis of the thermal runaway state of the battery.

The first cooling mode may be a mode in which the chiller and the EWP are driven, and the second cooling mode may be a mode in which the EWP is driven.

In this way, unlike the conventional technology that cuts off the battery power (main relay open) when thermal runaway of the battery occurs, the present disclosure turns on the battery power (main relay on) to drive the chiller and/or the EWP to the maximum, thereby maximizing cooling of the battery. Therefore, thermal runaway of the battery may be delayed as much as possible.

According to the present disclosure, there is an effect of delaying occurrence of a battery fire by suppressing thermal transfer in the most effective cooling mode at the time of occurrence of thermal runaway of the battery.

In particular, according to the present disclosure, unlike the conventional technology that cuts off the battery power (e.g., main relay open) when thermal runaway of the battery occurs, the battery power is turned on (e.g., main relay on) to drive the chiller and/or the EWP to the maximum, thereby maximizing cooling of the battery. Therefore, there is an effect that thermal runaway of the battery may be delayed as much as possible.

In addition, there is an effect of ensuring safety by maximizing an evacuation time of a user in case of a battery fire in an eco-friendly vehicle (for example, an EV, an HEV, and/or a PHEV).

In particular, according to the present disclosure, since an existing cooling system such as a chiller is used (e.g., to the maximum extent possible) to delay thermal runaway of the battery, there is an effect of reducing material costs associated with any additional hardware application for delaying thermal runaway of the battery.

In the specification of the present disclosure, use of the term “above” and similar referential terms may refer to both the singular and the plural. In addition, when a range is stated in the present disclosure, the statement includes the invention to which individual values within the range are applied (unless there is a statement to the contrary), and is the same as a statement of the individual values constituting the range in the detailed description of the invention.

Unless there is a statement of an explicit order or a statement to the contrary regarding steps constituting the method according to the present disclosure, the steps may be performed in any appropriate order. The present disclosure is not necessarily limited by the described order of the steps. Use of any examples or illustrative terms (for example, etc.) in the present disclosure is merely to describe the present disclosure in detail, and unless limited by the claims, the scope of the present disclosure is not limited by the examples or illustrative terms. Further, those skilled in the art will appreciate that various modifications, combinations, and changes may be made according to design conditions and factors within the scope of the appended claims or their equivalents.

Therefore, the spirit of the present disclosure should not be limited to the above-described examples, and the scope of the appended claims described below as well as all scopes equivalent to or equivalently changed from the claims are within the scope of the spirit of the present disclosure.

What is claimed is:

1. A cooling control device for delaying thermal runaway of a battery, the cooling control device comprising:
a thermal runaway diagnosis computing device configured to diagnose a thermal runaway state of the battery; and
a controller configured to, in response to the diagnosed thermal runaway state of the battery:
drive, based on a determination that a chiller powered by the battery is able to be driven, the chiller to cool the battery.

2. The cooling control device according to claim 1, wherein the controller is configured to drive, based on the determination, the chiller and an electric water pump (EWP).

3. The cooling control device according to claim 1, wherein the controller is configured to drive, based on a determination that the chiller is not able to be driven, an EWP without driving the chiller.

4. The cooling control device according to claim 1, further comprising a power management device configured to manage the battery,
wherein the power management device is configured to, based on the battery being turned off and based on control information from the controller, turn on the battery to supply power to the chiller.

5. The cooling control device according to claim 4, wherein the controller is configured to, based on the diagnosed thermal runaway state of the battery:
check, via the power management device, a power state of an ignition device; and
turn on the battery, to supply power to the chiller, further based on the check indicating the power state of the ignition device is off.

6. The cooling control device according to claim 5, wherein the controller is configured to:
verify, based on the power of the battery being in an on state, whether driving of the chiller is possible; and either
drive, based on the driving of the chiller being possible, the chiller and an EWP to cool the batter or
drive, based on the driving of the chiller not being possible, the EWP, without driving the chiller, to cool the battery.

7. The cooling control device according to claim 4, wherein the controller is configured to, based on the diagnosed thermal runaway state of the battery:
check, via the power management device, a power state of an ignition device;
verify, based on the power of the battery being on, whether driving of the chiller is allowed; and either
drive, based on the driving of the chiller being allowed, the chiller and an EWP to cool the battery; or
drive, based on driving of the chiller not being possible, the EWP without driving of the chiller.

8. A cooling control device for delaying thermal runaway of a battery, the cooling control device comprising:
a thermal runaway diagnosis unit configured to diagnose a thermal runaway state of the battery; and
a controller configured to, based on the diagnosed thermal runaway state of the battery, control cooling of the battery, wherein the cooling of the battery is controlled either in a first cooling mode based on a determination that a chiller for cooling the battery is able to be driven or in a second cooling mode based on a determination that the chiller is not able to be driven.

9. The cooling control device according to claim 8, wherein:
the first cooling mode is a mode in which the chiller and an electric water pump (EWP) are driven, and
the second cooling mode is a mode in which the EWP is driven without the chiller being driven.

10. The cooling control device according to claim 8, further comprising a power management device configured to manage the battery,
wherein the power management device is configured to, under control of the controller and based on power of the battery being turned off, turn on the power of the battery to supply the power to the chiller.

11. The cooling control device according to claim 10, wherein, the controller is configured to:
check, based on the diagnosed thermal runaway state and via the power management device, a power state of an ignition device; and
turn on the power of the battery, to supply power to the chiller, further based on the check indicating the power state of the ignition device is off.

12. The cooling control device according to claim 11, wherein the controller is configured to:
verify, based on the power of the battery being on, whether driving of the chiller is possible; and either
drive, based on the driving of the chiller being possible, the chiller and a EWP to cool the battery; or
drive, based on the driving of the chiller not being possible, the EWP without driving of the chiller.

13. The cooling control device according to claim 10, wherein the controller is configured to, based on the diagnosed thermal runaway state of the battery:
check, via the power management device, a power state of an ignition device;
verify, based on the power of the battery being on, whether driving of the chiller is possible; and either
drive, based on the driving of the chiller being possible, the chiller and an EWP to cool the battery; or
drive, based on the driving of the chiller not being possible, the EWP without driving of the chiller.

14. A cooling control method for delaying thermal runaway of a battery, the cooling control method comprising:
diagnosing a thermal runaway state of the battery; and
driving, based on a determination that a chiller powered by the battery is able to be driven, the chiller to cool the battery.

15. The cooling control method according to claim 14, wherein the driving comprises, based on determining power of the battery is turned off, turning on the power of the battery to supply power to the chiller.

16. A cooling control method for delaying thermal runaway of a battery, the cooling control method comprising:
diagnosing a thermal runaway state of the battery; and
based on the diagnosed thermal runaway state of the battery, controlling cooling of the battery, wherein the cooling of the battery is controlled either in a first cooling mode based on a determination that a chiller for cooling the battery is able to be driven or in a second cooling mode based on a determination that the chiller is not able to be driven.

17. The cooling control method according to claim 16, wherein:
the first cooling mode is a mode in which the chiller and an electric water pump (EWP) are driven, and
the second cooling mode is a mode in which the EWP is driven without the chiller being driven.

18. The cooling control method according to claim 16, wherein the controlling comprises:
checking, based on the diagnosed thermal runaway state of the battery, a power state of an ignition device; and
based on the power state being an off state, turning on the power of the battery.

19. The cooling control method according to claim 18, wherein the controlling further comprises:
verifying, based on the power of the battery being in an on state, whether driving of the chiller is possible; and either:
driving, based on the driving being verified possible, the chiller and an EWP to cool the battery, or driving, based on the driving not being verified possible, the EWP without driving the chiller.

20. The cooling control method according to claim 16, wherein the controlling comprises:
checking, based on the diagnosed thermal runaway state of the battery, a power state of an ignition device;
verifying, based on the power state being in an on state, whether driving of the chiller is possible; and either
driving, based on the driving being verified possible, the chiller and an EWP, or driving, based on the driving not being verified possible, the EWP without driving the chiller.
